(19) United States
(12) Patent Application Publication
(10) Pub. No.: US 2022/0188221 A1
(43) Pub. Date: Jun. 16, 2022

(54) REGRESSION TESTING METHOD AND REGRESSION TESTING APPARATUS

(71) Applicant: Xi'an Zhonglang Al Technology Co., Ltd, Xi'an (CN)

(72) Inventor: Qi Liu, Xi'an (CN)

(21) Appl. No.: 17/528,263

(22) Filed: Nov. 17, 2021

(30) Foreign Application Priority Data
Dec. 15, 2020 (CN) 202011484678.3

(51) Int. Cl. G06F 11/36

(52) U.S. Cl. CPC G06F 11/3688; G06F 11/3608; G06F 11/3664

(57) ABSTRACT

A regression testing method and a regression testing apparatus in a software test field are provided. In technical solutions provided in this application, when regression testing is performed, a testing environment of the regression testing is stored, and subsequent regression testing is performed based on the testing environment. The technical solutions provided in this application ensure consistency of testing environments between previous regression testing and latter regression testing, thereby improving accuracy of test results of the regression testing.

### CROSS REFERENCE TO RELATED APPLICATION

This patent application claims the benefit and priority of Chinese Patent Application No. CN 202011484678.3 filed on Dec. 15, 2020, the disclosure of which is incorporated by reference herein in its entirety as part of the present application.

### TECHNICAL FIELD

This application relates to a field of software testing, and in particular to a regression testing method and a regression testing apparatus.

### BACKGROUND

To meet requirements of customers and adapt to requirements of applications, a software system is frequently modified, and thus new versions are continuously issued during a life cycle of the software system, so that the modified software or a new version of software have some new functions added or some modifications in the software functions.

Regression testing usually needs to be performed on the software system after original codes are modified, for example a new function is introduced or the codes are adjusted, to confirm that during the modification to the original codes, no error is introduced to the software system.

In other words, each time some modifications are made to the software product, existing functions of the software product need to be retested, to determine whether the modifications achieve an expected purpose and check whether the modifications damage original normal functions. The regression testing needs to be performed to verify correctness and an effect of the modified software product.

Generally speaking, the higher the accuracy of the regression testing, the more accurately the problems in the software product can be found. Therefore, how to improve the accuracy of the regression testing is a technical problem that needs to be resolved urgently.

### SUMMARY

This application provides a regression testing method and a regression testing apparatus. In the technical solutions provided in this application, testing environment information for each testing of a software product is recorded, so that a consistent testing environment can be built based on the testing environment information during a subsequent regression testing, to improve test accuracy.

According to a first aspect, this application provides a regression testing method. The method includes: reading information on an initial testing environment, where the information on the initial testing environment indicates the initial testing environment for an initial software product; building a new testing environment for a new software product based on the information on the initial testing environment, where the new software product is obtained by improving the initial software product; performing regression testing on the new software product in the new testing environment; and recording information on the new testing environment, where the information on the new testing environment indicates the new testing environment.

Combined with the first aspect, in a first possible implementation, the building the new testing environment for the new software product based on the information on the initial testing environment includes: building the initial testing environment based on the information on the initial testing environment; and using the initial testing environment as the new testing environment for the new software product.

Combined with the first aspect, in a second possible implementation, the building the new testing environment for the new software product based on the information on the initial testing environment includes: building the initial testing environment based on the information on the initial testing environment; obtaining a difference between the new software product and the initial software product; and modifying the initial testing environment based on the difference, to obtain the new testing environment for the new software product.

According to a second aspect, this application provides a regression testing apparatus. The apparatus includes: a reading module, configured to read information on an initial testing environment, where the information on the initial testing environment indicates the initial testing environment for an initial software product; a building module, configured to building a new testing environment for a new software product based on the information on the initial testing environment, where the new software product is obtained by improving the initial software product; a testing module, configured to perform regression testing on the new software product in the new testing environment; and a recording module, configured to record information on the new testing environment, where the information on new testing environment indicates the new testing environment.

Combined with the second aspect, in a first possible implementation, the building module is specifically configured to: build the initial testing environment based on the information on the initial testing environment; and use the initial testing environment as the new testing environment for the new software product.

Combined with the second aspect, in the first possible implementation, the building module is specifically configured to: build the initial testing environment based on the information on the initial testing environment; obtain a difference between the new software product and the initial software product; and modify the initial testing environment based on the difference, to obtain the new testing environment for the new software product.

According to a third aspect, a regression testing apparatus is provided. The apparatus includes a processor. The processor is configured to execute a program stored in a memory. When the program stored in the memory is executed, the processor is configured to execute the method according to the first aspect or any one of the implementations of the first aspect.

In an embodiment, the apparatus may further includes the memory.

According to a fourth aspect, a computer-readable medium is provided. The computer-readable medium stores program code used by a device for execution. The program code is used to execute the method according to the first aspect or any one of the implementations of the first aspect.

According to a fifth aspect, a computer program product including instructions is provided. When the computer program product runs on a computer, the computer is enabled to execute the method according to the first aspect or any one of the implementations of the first aspect.

According to a sixth aspect, a chip is provided. The chip includes a processor and a data interface. The processor reads instructions stored in a memory via the data interface, and executes the method according to the first aspect or any one of the implementations of the first aspect.

In an embodiment, in an implementation, the chip may further include a memory. The memory stores instructions. The processor is configured to execute the instructions stored in the memory. When the instructions are executed, the processor is configured to execute the method according to the first aspect or any one of the implementations of the first aspect.

According to a seventh aspect, a computing apparatus is provided. The computing apparatus includes: a memory, configured to store a program; and a processor, configured to execute the program stored in the memory. When the program stored in the memory is executed, the processor is configured to execute the method according to the first aspect or any one of the implementations of the first aspect.

### BRIEF DESCRIPTION OF THE DRAWINGS

FIG. 1 is a schematic diagram of an application scenario to which technical solutions according to embodiments of this application are applicable;

FIG. 2 is a schematic flow diagram of a regression testing method according to an embodiment of this application;

FIG. 3 is a schematic structural diagram of a regression testing apparatus according to an embodiment of this application; and

FIG. 4 is a schematic structural diagram of a regression testing apparatus according to another embodiment of this application.

### DETAILED DESCRIPTION OF THE EMBODIMENTS

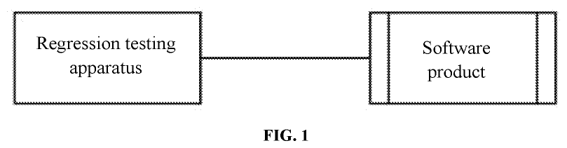

FIG. 1 is a schematic diagram of an application scenario of technical solutions according to embodiments of this application. The application scenario may include a regression testing apparatus and a software product. The software product may be an embedded system.

In the application scenario, the regression testing apparatus needs to build a testing environment for the software product when performing regression testing on the software product. In the conventional art, in different rounds of regression testing for a same software product, the regression testing apparatus dynamically build testing environments for the software product, which may make the regression testing environments of the different rounds differ greatly, and thus affect recurrence of some problems of the software product, and then affect test accuracy.

This application provides new technical solutions on the foregoing problem. In the technical solutions provided in this application, with respect to each round of regression testing for a software product, information on a testing environment is recorded with respect to this round of regression testing, and based on the information on the testing environment, a testing environment is built with respect to a next round of regression testing for the software product, so that testing environments of different rounds are consistent, thereby improving test accuracy.

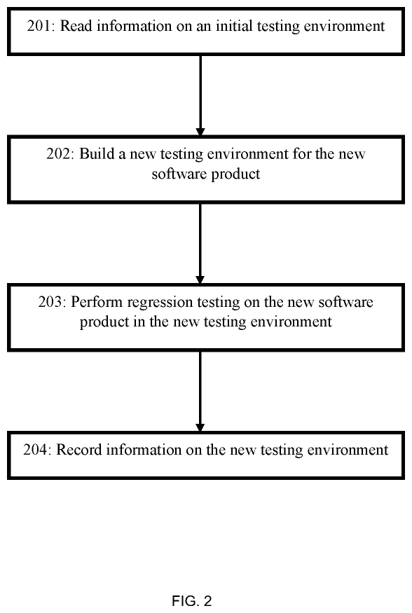

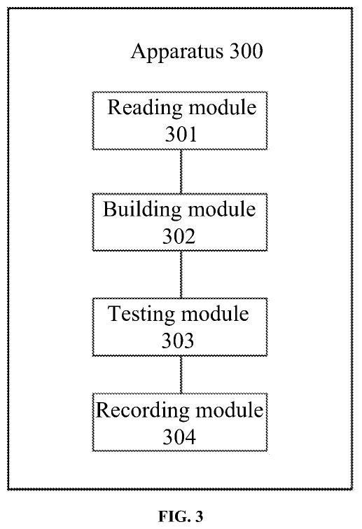

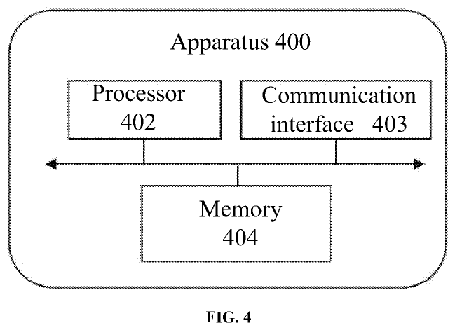

FIG. 2 is a schematic flow diagram of a regression testing method according to an embodiment of this application. As shown in FIG. 2, the method may include step 201, step 202, step 203, and step 204. The method may be executed by a regression testing apparatus shown in FIG. 3 or FIG. 4.

Step 201: information on an initial testing environment is read, where the information on the initial testing environment indicates an initial testing environment for an initial software product.

Taking the application scenario shown in FIG. 1 as an example, the regression testing apparatus reads the information on the initial testing environment from a memory.

In this embodiment, the initial testing environment is an environment used for testing the initial software product last time. Additionally, in this embodiment, the initial software product and a new software product refer to different development versions of a same software product, and the new software product is usually obtained by modifying or improving the initial software product. The software product in this embodiment may be an embedded system.

In this embodiment, the testing environment may include a hardware environment and/or a software environment. The hardware environment may refer to an environment including a server, a client, and a network connection device necessary for testing. The software environment may refer to an environment including an operating system, a database, and other application software for running the tested software.

Step 202: A new testing environment for the new software product is built based on information on the initial testing environment, where the new software product is obtained by improving the initial software product.

In an example, building the new testing environment for the new software product based on the information on the initial testing environment may include: building the initial testing environment based on the information on the initial testing environment; and using the initial testing environment as the new testing environment for the new software product.

The implementation in this example can ensure complete consistency of testing environments for different rounds of regression testing, thereby improving the test accuracy.

In another example, building the new testing environment for the new software product based on the information on the initial testing environment may include: building the initial testing environment based on the information on the initial testing environment; obtaining a difference between the new software product and the initial software product; and modifying the initial testing environment based on the difference, to obtain the new testing environment for the new software product.

The implementation in this example can ensure consistency of testing environments for different rounds of regression testing, and ensure that the new testing environment can conform to an improvement of the software product, thereby improving the test accuracy.

Step 203: Regression testing is performed on the new software product in the new testing environment. An implementation of the step refer to the prior art. Details are not described herein again.

Step 204: Information on the new testing environment is recorded, where the information on the new testing environment indicates the new testing environment.

It may be understood that an execution sequence of step 203 and step 204 is not limited in this embodiment. Step 204 may be after step 203, or step 203 and step 204 may be performed simultaneously.

In the regression testing method in this embodiment, steps 201 to 204 may be executed repeatedly. It may be understood that the information on the initial testing environment read in step 201 each time is the information on the new testing environment recorded in a previous regression testing process.

FIG. 3 is a schematic structural diagram of a regression testing apparatus 300 according to an embodiment of this application. The apparatus 300 may include: a reading module 301, a building module 302, a testing module 303, and a recording module 304.

The reading module 301, the building module 302, the testing module 303, and the recording module 304 may be implemented by using a processor.

The apparatus 300 may be configured to perform the method shown in FIG. 2. For example, the reading module 301 may be configured to perform step 201, the building module 302 may be configured to perform step 202, the testing module may be configured to perform step 203, and the recording module 304 may be configured to perform step 204.

For example, the reading module 301 is configured to read information on an initial testing environment, where the information on the initial testing environment indicates the initial testing environment for an initial software product.

The building module 302 is configured to build a new testing environment for a new software product based on the information on the initial testing environment, where the new software product is obtained by improving the initial software product.

The testing module 303 is configured to perform regression testing on the new software product in the new testing environment.

The recording module 304 is configured to record the information on the new testing environment, where the information on the new testing environment indicates the new testing environment.

In a possible implementation, the building module is specifically configured to: build the initial testing environment based on the information on the initial testing environment; and use the initial testing environment as the new testing environment for the new software product.

In a possible implementation, the building module is specifically configured to: build the initial testing environment based on the information on the initial testing environment; obtain a difference between the new software product and the initial software product; and modify the initial testing environment based on the difference, to obtain the new testing environment for the new software product.

FIG. 4 is a schematic structural diagram of a regression testing apparatus 400 for testing according to an embodiment of this application. The apparatus 400 includes a processor 402, a communication interface 403, and a memory 404. In one example, the apparatus 400 is a chip, and in another example, the apparatus 400 is a computing device.

The processor 402, the memory 404, and the communication interface 403 may communicate via a bus. The memory 404 stores executable code. The processor 402 reads the executable code in the memory 404 to execute a corresponding method. The memory 404 may also include software modules, such as an operating system, required for running a process. The operating system may be LINUX™, UNIX™, WINDOWS™, and the like.

For example, the executable codes in the memory 404 are used to implement the steps or operations in FIG. 2; and the processor 402 reads the executable codes in the memory 404 to execute step 201 to step 204 in FIG. 2.

The processor 402 may be a CPU. The memory 404 may include a volatile memory such as a random access memory (RAM). The memory 404 may also include a non-volatile memory (NVM) such as a read-only memory (ROM), a flash memory, a hard disk drive (HDD), or a solid state disk (SSD).

A person of ordinary skill in the art may be aware that units and algorithm steps in examples described with reference to the embodiments disclosed in this specification can be implemented by an electronic hardware or a combination of computer software and electronic hardware. Whether these functions are implemented by hardware or software depends on specific application and design constraints of a technical solution. A person skilled in the art may use different methods to implement the described functions for each specific application, but such implementation should not be considered to go beyond the scope of this application.

A person skilled in the art can clearly understand that, for convenience and brevity of description, reference may be made to corresponding processes in the foregoing method embodiment for specific working processes of the foregoing systems, apparatuses, and units. Details are not described herein again.

In several embodiments provided in this application, it should be understood that the disclosed system, apparatus, and method may be implemented in other manners. For example, the apparatus embodiment described above is merely an example. For example, units are merely divided according to logical function and may be divided based on other division manner during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and a part displayed as a unit may or may not be a physical unit, may be located in one position, or may be distributed on a plurality of network units. Some or all of units may be selected according to actual requirements to achieve the objectives of the solutions in the embodiments.

In addition, function units in the embodiments of this application may be integrated into one processing unit, or each of the units may exist alone physically, or two or more units are integrated into one unit.

If implemented in a form of a software functional unit and sold or used as a stand-alone product, functions may be stored in a computer-readable storage medium. Based on such understanding, the technical solution in this application essentially, or the part contributing to the prior art, or some of the technical solutions may be embodied in a form of a software product. The computer software product is stored in a storage medium, and includes several instructions to enable a computer device (which may be a personal computer, a server, a network device, or the like) to execute all or some steps of the method according to the embodiments of this application. The foregoing storage medium includes any medium that can store program codes, such as a USB flash disk, a removable hard disk, a read-only memory, a random access memory, a magnetic disk, or an optical disc.

The above merely describes specific implementations of this application, but the protection scope of this application is not limited thereto. Any person skilled in the art can easily conceive modifications or replacements within the scope of this application, and these modifications or replacements shall fall within the protection scope of this application. Therefore, the protection scope of this application should be defined by the protection scope of the claims.

What is claimed is:

1. A regression testing method, comprising:
reading information on an initial testing environment, wherein the information on the initial testing environment indicates the initial testing environment for an initial software product;
building a new testing environment for a new software product based on the information on the initial testing environment, wherein the new software product is obtained by improving the initial software product;
performing regression testing on the new software product in the new testing environment; and
recording information on the new testing environment, wherein the information on the new testing environment indicates the new testing environment.

2. The method according to claim 1, wherein the building the new testing environment for the new software product based on the information on the initial testing environment comprises:
building the initial testing environment based on the information on the initial testing environment; and
using the initial testing environment as the new testing environment for the new software product.

3. The method according to claim 1, wherein the building the new testing environment for the new software product based on the information on the initial testing environment comprises:
building the initial testing environment based on the information on the initial testing environment;
obtaining a difference between the new software product and the initial software product; and
modifying the initial testing environment based on the difference, to obtain the new testing environment for the new software product.

4. A regression testing apparatus, comprising:
a reading module, configured to read information on an initial testing environment, wherein the information on the initial testing environment indicates the initial testing environment for an initial software product;
a building module, configured to build a new testing environment for a new software product based on the information on the initial testing environment, wherein the new software product is obtained by improving the initial software product;
a testing module, configured to perform regression testing on the new software product in the new testing environment; and
a recording module, configured to record information on the new testing environment, wherein the information on the new testing environment indicates the new testing environment.

5. The apparatus according to claim 4, wherein the building module is configured to:
build the initial testing environment based on the information on the initial testing environment; and
use the initial testing environment as the new testing environment for the new software product.

6. The apparatus according to claim 4, wherein the building module is configured to:
build the initial testing environment based on the information on the initial testing environment;
obtain a difference between the new software product and the initial software product; and
modify the initial testing environment based on the difference, to obtain the new testing environment for the new software product.

7. A chip, comprising a processor, wherein the processor is coupled to a memory;
the memory is configured to store instructions; and
the processor is configured to execute the instructions stored in the memory, to implement the method according to claim 1.

8. The chip according to claim 7, wherein the building the new testing environment for the new software product based on the information on the initial testing environment comprises:
building the initial testing environment based on the information on the initial testing environment; and
using the initial testing environment as the new testing environment for the new software product.

9. The chip according to claim 7, wherein the building the new testing environment for the new software product based on the information on the initial testing environment comprises:
building the initial testing environment based on the information on the initial testing environment;
obtaining a difference between the new software product and the initial software product; and
modifying the initial testing environment based on the difference, to obtain the new testing environment for the new software product.

10. A computer-readable medium, comprising instructions, wherein when the instructions are run on a processor, the processor is enabled to implement the method according to claim 1.

11. A computer-readable medium according to claim 10, wherein the building the new testing environment for the new software product based on the information on the initial testing environment comprises:
building the initial testing environment based on the information on the initial testing environment; and
using the initial testing environment as the new testing environment for the new software product.

12. A computer-readable medium according to according to claim 10, wherein the building the new testing environment for the new software product based on the information on the initial testing environment comprises:
building the initial testing environment based on the information on the initial testing environment;
obtaining a difference between the new software product and the initial software product; and
modifying the initial testing environment based on the difference, to obtain the new testing environment for the new software product.

13. A computing device, comprising a processor and a memory, wherein the processor is coupled to the memory;
the memory is configured to store instructions; and
the processor is configured to execute the instructions stored in the memory, to enable the computing device to implement the method according to claim 1.

14. The computing device according to claim 13, wherein the building the new testing environment for the new software product based on the information on the initial testing environment comprises:
building the initial testing environment based on the information on the initial testing environment; and
using the initial testing environment as the new testing environment for the new software product.

15. The chip according to claim 13, wherein the building the new testing environment for the new software product based on the information on the initial testing environment comprises:
building the initial testing environment based on the information on the initial testing environment;
obtaining a difference between the new software product and the initial software product; and
modifying the initial testing environment based on the difference, to obtain the new testing environment for the new software product.
